(19) United States
(12) Patent Application Publication
(10) Pub. No.: US 2008/0319783 A1
(43) Pub. Date: Dec. 25, 2008

(54) Charging Method, System and Server for PoC Service

(75) Inventors: Jing YAO, Shenzhen (CN); Dong ZHAO, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/205,837

(22) Filed: Sep. 5, 2008

Related U.S. Application Data
(63) Continuation of application No. PCT/CN2007/000715, filed on Mar. 6, 2007.

(30) Foreign Application Priority Data
Mar. 7, 2006 (CN) 200610034241.3

(51) Int. Cl. G06Q 30/00; G06F 15/16

(52) U.S. Cl. 705/1; 709/228

(57) ABSTRACT

A charging method, a system and a server for Poc service are disclosed. The Poc server transmits updating CCR message to OCS when the number of the clients participated in conversation changes, the message carries the information of the number of the clients participated in the conversation. The present invention could provide the charging scheme based on the number of the clients participated in the conversation to the user, therefore the diversiform charging requirements of operators are fulfilled and the satisfaction degree of users is increased.

### CROSS-REFERENCE TO RELATED APPLICATION

This application is a continuation of International Patent Application No. PCT/CN2007/000715, filed Mar. 6, 2007, which claims priority to Chinese Patent Application No. 200610034241.3, filed Mar. 7, 2006, each of which is hereby incorporated by reference in its entirety.

### FIELD OF THE INVENTION

The present invention relates to the field of communications, in particular, to a method, a system and a server for charging a PoC service.

### BACKGROUND OF THE INVENTION

The Push-to-talk over Cellular (PoC) service is a PTT (Push-to-Talk) service employing VoIP technology and based on Mobile Cellular Public Network. After setting a group list, a PoC terminal user may carry out a point-to-point semi-duplex communication with other PoC users or carry out a point-to-multipoint semi-duplex communication with users in a pre-configured group simply by pressing a dedicated key. The PoC service was first released by an American mobile carrier, Nextel, in 1993. At present, the PTT service, which is based on cellular system, introduces more functions such as instant text message and instant image message into voice service. As a result, voice service is endued with new contents.

The deployment of PoC services may be independent of the underlay bearer network, and may be realized via semi-duplex VoIP technology while making full use of the underlay bearer network. The PoC service provides a simple and easy way to meet the requirement of users on real-time, semi-duplex voice communication, and it may provide functions such as point-to-point communication, point-to-multipoint communication and instant user notification. The Point-to-multipoint communication includes three types of group communication: customized group (ad-hoc), pre-arranged group and chat group.

FIG. 1 shows the architecture of a PoC network based on IP Multimedia System (IMS), in which the PoC server is the main processing unit of the PoC service. The PoC server is provided with the functions such as PoC session processing, media distribution, floor control processing, user plane adaptation, and coding protocol conversion.

The function of Presence Server is receiving and storing the presence information published by a User Equipment (UE), and distributing the presence information to other PoC clients. Common presence information includes “Whether Online,” “Do-not-Disturb,” and so on.

XML Document Management Server (XDMS) is adapted to manage the group and list required by the PoC service, and to provide functions of adding, modifying and deleting PoC group information, and authorization and control of a group.

Service CSCF (S-CSCF) and Proxy CSCF (P-CSCF) are logical entities of CSCF (Call Server Control Function) as core components of IMS. S-CSCF performs session control on the service, and P-CSCF is the first contact point in the IMS subsystem for a user.

UE (User Equipment) acts as a PoC client to perform PoC call processing and media processing, etc.

In the architecture of IMS network, Ut interface provides the function of communication between XDMS and UE. Gm interface are primarily adapted for the transmission of the registration-related flow, and user service control and authentication-related flows between a UE and a CSCF. Mw interface lies between CSCFs, and allows querying the mobile terminal call to an S-CSCF directed by a CSCF. S-CSCF is connected to the PoC server, Presence Server and XDMS via an IMS Service Control (ISC) interface.

In the PoC service, charging includes offline charging and online charging. When offline charging is performed, the charging information may not influence the implementation of the service in real time; on the contrary, when online charging is performed, the charging information may influence the implementation of the service in real time. Therefore, a set of mechanisms are required to implement the direct interaction of the session and the service control, etc. The online charging and offline charging are realized via an Online Charging System (OCS) and a Charging Data Function (CDF) entity, respectively. The OCS and CDF may exist in the PoC server, S-CSCF, or P-CSCF.

FIG. 2 shows a message flow for online charging a PoC session initiated by a PoC Client. After receiving a session establishment request (SIP INVITE) from a PoC Client, a PoC Server triggers a Credit Control Request (CCR) to an OCS. The OCS performs Quota Reservation on the credit of the user according to the CCR, and returns a Credit Control Answer (CCA) to the PoC Server. The PoC Server controls the session of the PoC Client according to the credit quota reserved by the OCS (i.e., Start Quota Control).

FIG. 3 shows a message flow for offline charging a PoC session initiated by a PoC Client. After receiving a session establishment request from a PoC Client, a PoC Server saves the charging data, and triggers an Accounting Request (ACR) to a CDF. The CDF creates a Charging Data Record (CDR) according to the ACR, and returns an Accounting Answer (ACA) to the PoC Server.

When a user subscribes to a PoC service, the carrier may be required to provide a very flexible pricing standard. For example, the call initiator or the group management party may be charged according to the number of PoC session clients. The existing charging solution is monotonous, and charging based on the number of the participating clients is absent, so it is difficult to meet the diversified requirements of the carrier.

### SUMMARY OF THE INVENTION

Embodiments of the invention provide a method for online and offline charging a PoC service, in order to solve the problem in the prior art that in the charging of a PoC service, there lacks a charging mode based on the number of the participating clients, so that it is difficult to meet the demands of the carrier on diversified charging.

The embodiments of the invention further provide a system for charging the PoC service, and a PoC server for realizing online and offline charging to address the problem that the existing charging solution is monotonous and lacks a charging mode based on the number of participating clients.

In view of the above technical problems, an embodiment of the invention provides a method for online charging a PoC service, which includes:

when the number of session-participating clients changes, a PoC server initiates a Credit Control update Request, i.e. CCR (update) to an OCS and reports the number of the session-participating clients.

Correspondingly, an embodiment of the invention further provides a method for offline charging a PoC service, which includes:

when the number of session-participating clients changes, a PoC server initiates an ACR to a CDF, and reports the number of the session-participating clients.

Additionally, an embodiment of the invention further provides a PoC server for online charging which communicates with an OCS and online charges a PoC service. The PoC server includes:

a Number-Of-Participants update unit, adapted to initiate a CCR (update) to the OCS, and to report and update the number of session-participating clients, when the number of the session-participating clients changes.

Correspondingly, an embodiment of the invention further provides a PoC server for offline charging which communicates with a CDF and offline charges a PoC service. The PoC server includes:

a Number-Of-Participants update unit, adapted to initiate an ACR to the CDF and report the number of session-participating clients, when the number of the session-participating clients changes.

Additionally, an embodiment of the invention further provides a system for charging a PoC service, which includes:

an OCS, adapted to charge a PoC service when the session-participating client is online; and/or

a CDF, adapted to charge a PoC service when the session-participating client is offline; and

a Number-Of-Participants update unit, connected with an OCS or/and a CDF respectively, for initiating a CCR (update) to the OCS or initiating an ACR to the CDF, and reporting and/or updating the number of session-participating clients, when the number of the session-participating clients changes.

It can be seen from the above technical solutions that in the embodiments of the invention, offline and online charging are provided when the number of participants changes. In other words, during the online charging of a PoC session, the number of clients written in a CCR message is the number of clients invited to the session by the session-initiating client. If the number of participants changes (increases or decreases), the Number-Of-Participants information is re-written and updated via the CCR message. The re-written number of participants is the actual number of the session-participating clients at present. Similarly, during the offline charging of a PoC session, if the number of the session-participating clients changes (increases or decreases), the Number-Of-Participants information is re-written and updated via an ACR message. The re-written number of participants is the actual number of the session-participating clients at present. Therefore, in the technical solutions according to the embodiments of the invention, a charging mode based on the number of clients participating in a PoC session may be provided to the user. This charging mode is simple and flexible, and can meet the demands of the carrier on diversified charging, and therefore user satisfaction level may be improved.

### BRIEF DESCRIPTION OF THE DRAWINGS

FIG. 1 is a schematic diagram showing the architecture of a PoC network based on IMS in the conventional art;

FIG. 2 is a message flow chart for online charging a PoC session in the conventional art;

FIG. 3 is a message flow chart for offline charging a PoC session in the conventional art;

FIG. 4 is a flow chart of online charging when a session-initiating client participates in a PoC session in the method according to an embodiment of the invention;

FIG. 5 is a flow chart of online charging when a session-initiating client leaves a PoC session in the method according to an embodiment of the invention;

FIG. 6 is a flow chart of offline charging when a session-initiating client participates in a PoC session in the method according to an embodiment of the invention;

FIG. 7 is a flow chart of offline charging when a session-initiating client leaves a PoC session in the method according to an embodiment of the invention;

FIG. 8 is a flow chart of online charging when a session-participating client participates in a PoC session in the method according to an embodiment of the invention;

FIG. 9 is a flow chart of online charging when a session-participating client leaves a PoC session in the method according to an embodiment of the invention;

FIG. 10 is a flow chart of offline charging when a session-participating client participates in a PoC session in the method according to an embodiment of the invention;

FIG. 11 is a flow chart of offline charging when a session-participating client leaves a PoC session in the method according to an embodiment of the invention;

FIG. 12 is a structural diagram of a system for charging a PoC service according to an embodiment of the invention;

FIG. 13 is a structural diagram of a PoC server for online charging according to an embodiment of the invention; and

FIG. 14 is a structural diagram of a PoC server for offline charging according to an embodiment of the invention.

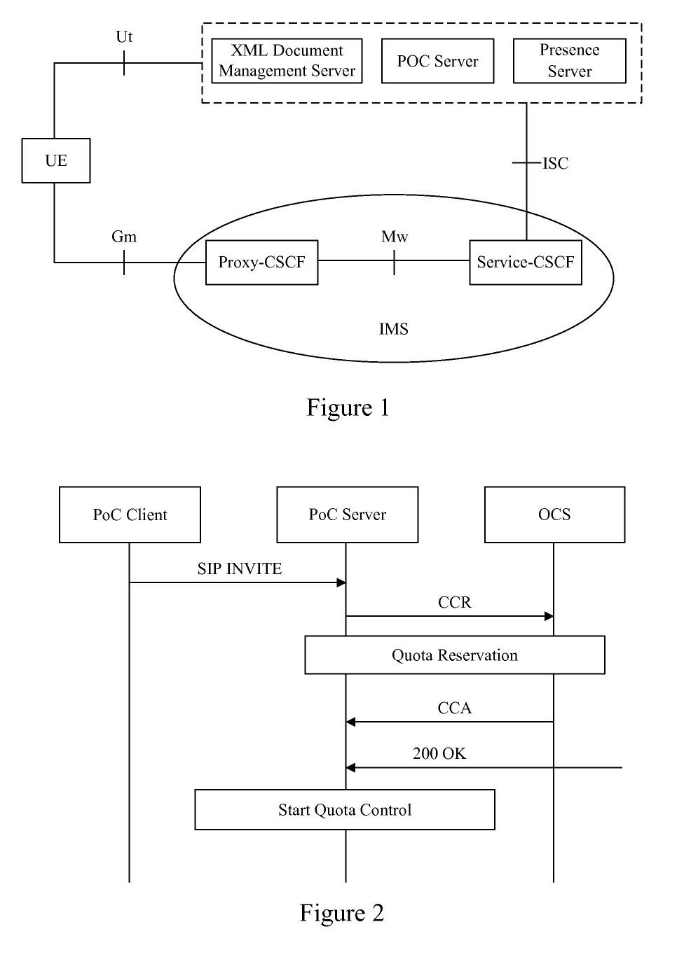

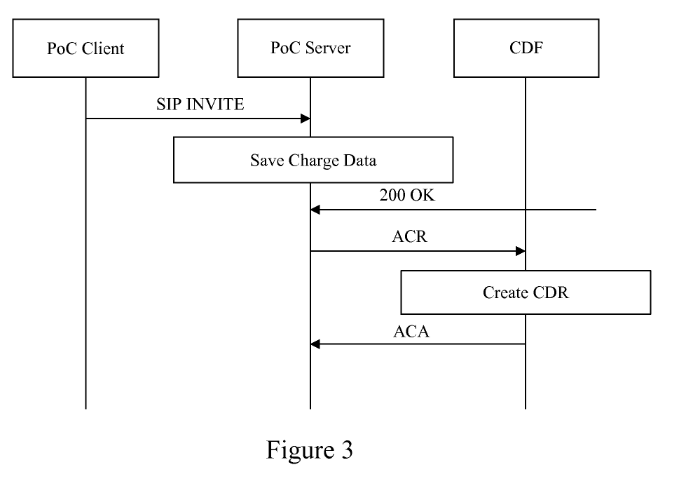

### DETAILED DESCRIPTION OF THE EMBODIMENTS

To make the objects, technical solutions and advantages of the invention more apparent, the invention will be further illustrated in detail in conjunction with the drawings and embodiments. It is to be understood that the embodiments described herein are used for illustrating the invention only, rather than limiting the scope of the invention.

In an embodiment of the invention, a message flow for charging when the number of session-participating clients changes is provided in the PoC session. When the number of session-participating clients changes (increases or decreases), the number of the session-participating clients is updated via a CCR or an ACR, so that the carrier may charge the session-participating client or the session-initiating client according to the number of the session-participating clients.

In one embodiment of the invention, only the session-initiating client is charged, but the session-participating client is not charged. However, the number of the session-participating clients may influence the charging on the session-initiating client.

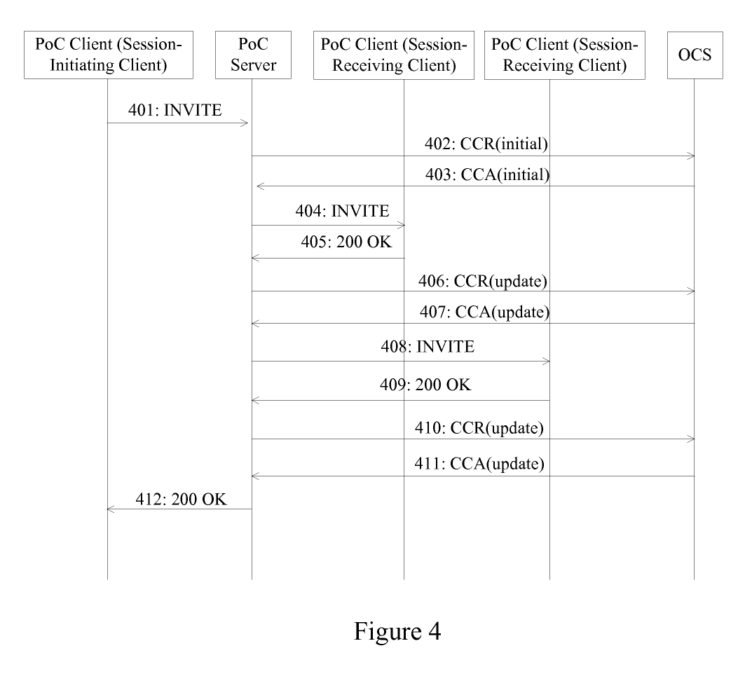

FIG. 4 is a flow chart of online charging when a session-initiating client participates in a PoC session according to an embodiment of the invention. In the invention, exemplified with two session-participating clients, the process of online charging when a new client participates in the session is described.

When a PoC Client (session-initiating client) initiates a session, the information of the number of session-participating clients is written in an initial Credit Control Request, i.e. CCR (initial) message by a PoC Server. The written number of clients is the number of clients invited to participate in the session by the session-initiating client.

When a new PoC Client (session-receiving client) participates in the session, the PoC Server reports the information of the number of session-participating clients to an OCS via a CCR (update) message. The written number of clients in the message CCR is the actual number of the session-participating clients at present. The process is as follows:

401) A PoC Client (session-initiating client) initiates a session request (INVITE) to a PoC Server;

402) The PoC Server sends a CCR (initial) message to an OCS; in the message, the number of the clients invited to participate in the session is carried in the “Number-Of-Participants” cell of the message;

403) The PoC Server receives an initial Credit Control Answer, i.e. CCA (initial) sent from the OCS;

404) The PoC Server initiates a session request (INVITE) to the first PoC Client invited to the session;

405) The PoC Client sends a success answer (200 OK) to the PoC Server;

406) The PoC Server sends a Credit Control update Request, i.e. CCR (update) message to the OCS; in the message, the updated number of session-participating clients is carried in the “Number-Of-Participants” cell of the message;

407) The OCS returns a Credit Control update Answer, i.e. CCA (update) to the PoC Server;

408) The PoC Server initiates a session request (INVITE) to the second PoC Client invited to the session;

409) The PoC Client sends a success answer (200 OK) to the PoC Server;

410) The PoC Server sends a CCR (update) message to the OCS; in the message, the updated number of session-participating clients is carried in the “Number-Of-Participants” cell of the message;

411) The OCS returns a CCA (update) to the PoC Server; and

412) The PoC Server returns a success answer (200 OK) to the PoC Client (session-initiating client).

It can be seen from the above process that in this embodiment, the CCR (initial) message is updated and written in real time depending on the change of the number of session-participating clients. The Number-Of-Participants information written in the CCR (initial) message is the number of clients invited to participate in the session by the session-initiating client, and the number of clients re-written through the CCR (update) is the actual number of the session-participating clients at present. However, in the prior art, only the number of clients invited to participate in the session is written.

The structure of the CCR (update) message is shown in Table 1; in other words, Table 1 shows the structure of the message CCR (update) which carries the Number-Of-Participants information in the above process; and the number of the current session-participating clients is carried in the “Number-Of-Participants” cell.

TABLE 1

| Message Title | Message Content |
|---|---|
| Session-Id | Session ID |
| Origin-Host | Origin Host |
| Origin-Realm | Origin Realm |
| Destination-Realm | Destination Realm |
| Auth-Application-Id | ID of Charging Instance |
| Service-Context-Id | ID of service context |
| CC-Request-Type | Type of Charging Record |
| CC-Request-Number | Number of Charging Record |
| Destination-Host | Destination Host |
| User-Name | User Name |
| Event-Timestamp | ID of Charging Instance |
| | Customized by the Carrier |
| Subscription-Id | User Subscription ID |
| Service-Identifier | Type of Service Identity |
| PoC-Server-Role | Indicate whether the PoC |
| | server is a control PoC |
| | server or a participating |
| | PoC server |
| PoC-Session-Type | Type of PoC Session |
| Number-Of-Participants | The number of session- |
| | participating clients |
| List-Of-Participants | Address of session- |
| | participating clients |
| List-Of-Talk-Burst-Exchange | Only applicable for offline |
| | charging, which lists the |
| | change of charging conditions |
| | of the PoC session, with each |
| | change time-stamped. |
| Extension | Extension |

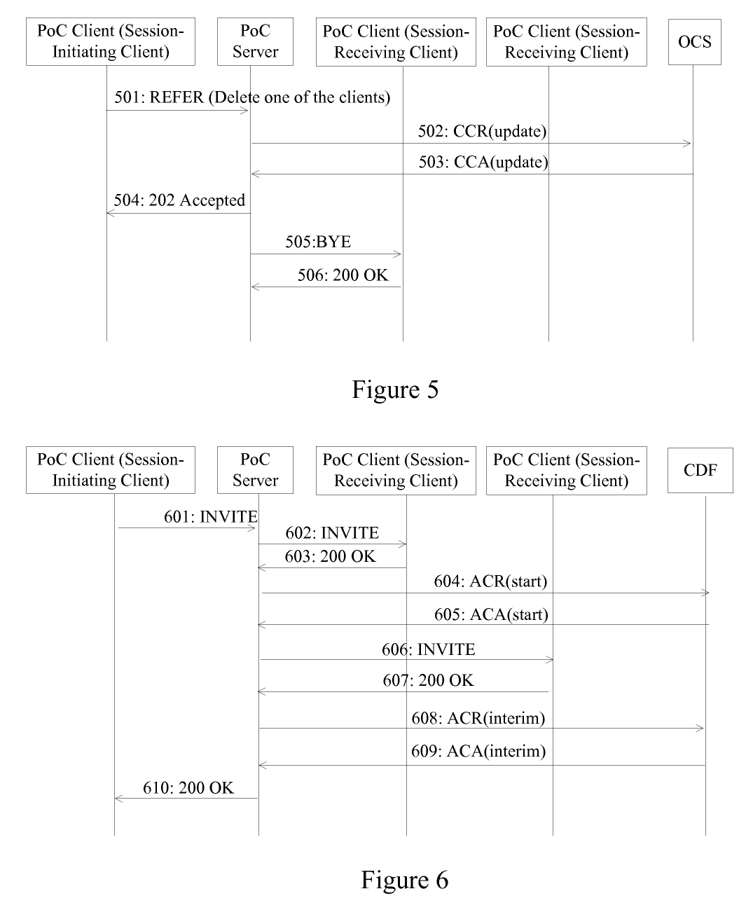

Similarly, when online charging for a PoC point-to-multipoint session, in the case that a user of the session-initiating client leaves the session, the PoC Server also sends a CCR (update) message to the OCS, and the Number-Of-Participants information is updated in the message; in other words, the number of session-participating clients is updated. FIG. 5 is a flow of online charging when a user of the session-initiating client leaves the session, including the following steps:

501) A PoC Client (session-initiating client) sends a deletion request to a PoC Server for deleting one of the session-participating clients;

502) The PoC Server sends a CCR (update) message to the OCS; in the message, the updated number of the session-participating clients is carried in the “Number-Of-Participants” cell of the message;

503) The OCS returns a CCA (update) to the PoC Server;

504) The PoC Server returns a deletion-accepted message (202 Accepted) to the PoC Client (session-initiating client);

505) The PoC Server sends a deletion request (BYE) to the PoC Client that leaves the session; and

506) The PoC Client that leaves the session returns a deletion success answer (200 OK) to the PoC Server.

FIG. 6 shows, exemplified with two session-participating clients, a flow chart of offline charging when a session-initiating client participates in a PoC session according to an embodiment of the invention.

A PoC Client (session-initiating client) initiates a session. No credit quota needs to be reserved in the case of offline charging. After a PoC Client (session-receiving client) participates in the session, the Number-Of-Participants information is written in an Accounting-start Request, i.e. ACR (start) message sent to the CDF by the PoC Server. The written number of clients is the actual number of the session-participating clients. When a new PoC Client (session-receiving client) participates in the session, the Number-Of-Participants information is re-written via an ACR (interim). The re-written number of clients is the actual updated number of the session-participating clients. The process includes:

601) The PoC Client initiates a session request (INVITE);

602) The PoC Server initiates a session request (INVITE) to the first PoC Client invited to the session;

603) The PoC Server receives a success answer (200 OK) sent from the PoC Client;

604) The PoC Server initiates an ACR (start) to the CDF, and the number of session-participating clients is carried in the “Number-Of-Participants” cell;

605) The PoC Server receives an Accounting-start Answer, i.e. ACA (start) that is sent from the CDF;

606) The PoC Server initiates a session request (INVITE) to the second PoC Client invited to the session;

607) The PoC Server receives a success answer (200 OK) sent from the PoC Client;

608) The PoC Server initiates an interim Accounting Request, i.e. ACR (interim) to the CDF, and the updated number of session-participating clients is carried in the “Number-Of-Participants” cell;

609) The PoC Server receives an interim Accounting Answer, i.e. ACA (interim) sent from the CDF; and

610) The PoC session-initiating Client receives a success answer (200 OK).

In this embodiment, the CCR (initial) message is updated and written in real time depending on the change of the number of the session-participating clients. The number of clients written in the message ACR (start) and ACR (interim) is the actual number of the session-participating clients at present, while in the prior art, the number of the invited clients is written.

The structure of the CCR (update) message is shown in Table 2; in other words, Table 2 shows the structure of the ACR message that carries the Number-Of-Participants information in the above process, where the number of session-participating clients is carried in the “Number-Of-Participants” cell.

TABLE 2

| Message Title | Message Content |
|---|---|
| Session-Id | Session ID |
| Origin-Host | Origin Host |
| Origin-Realm | Origin Realm |
| Destination-Realm | Destination Realm |
| Accounting-Record-Type | Type of Charging Record |
| Accounting-Record-Number | Number of Charging Record |
| Acct-Application-Id | ID of Charging Instance |
| Vendor-Specific-Application-Id | ID of Charging Instance |
| | Customized by the Carrier |
| User-Name | User Name |
| Event-Timestamp | Timestamp of an event |
| PoC-Server-Role | Indicate whether the PoC |
| | server is a control PoC |
| | server or a participating |
| | PoC server |
| PoC-Session-Type | Type of PoC Session |
| Number-Of-Participants | The number of session- |
| | participating clients |
| List-Of-Participants | Address of session- |
| | participating clients |
| Extension | Extension |

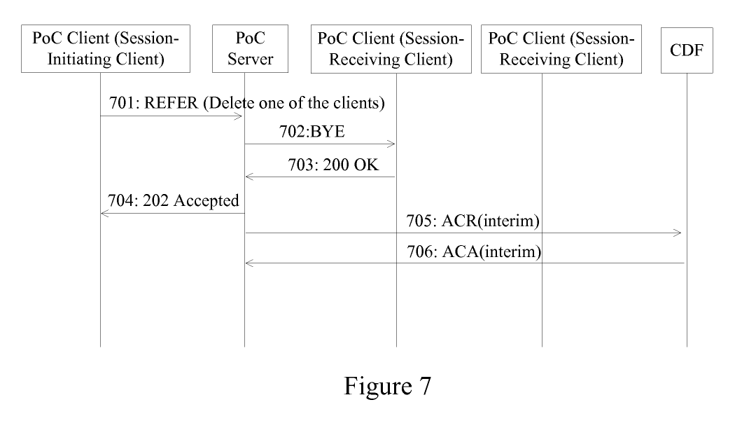

Similarly, when offline charging for a PoC point-to-multipoint session, in the case that a user of the session-initiating client leaves the session, the PoC Server also sends an ACR message to the CDF, and the Number-Of-Participants information is updated in the message; in other words, the number of session-participating clients is updated, as shown in FIG. 7. The process includes:

701) A PoC Client (session-initiating client) sends a deletion request to a PoC Server for deleting one of the session-participating clients;

702) The PoC Server sends a deletion request (BYE) to the PoC Client that leaves the session;

703) The PoC Client that leaves the session returns a deletion success answer (200 OK) to the PoC Server;

704) The PoC Server returns a deletion-accepted message (202 Accepted) to the PoC Client (session-initiating client);

705) The PoC Server initiates an ACR (interim) to the CDF, where the updated number of session-participating clients is carried in the “Number-Of-Participants” cell; and

706) The CDF returns an ACA (interim) to the PoC Server.

Additionally, besides the session-initiating client may be charged, the session-participating client may also be charged in the embodiments. In this case, the OCS or CDF is required to exchange the charging message with the session-participating clients.

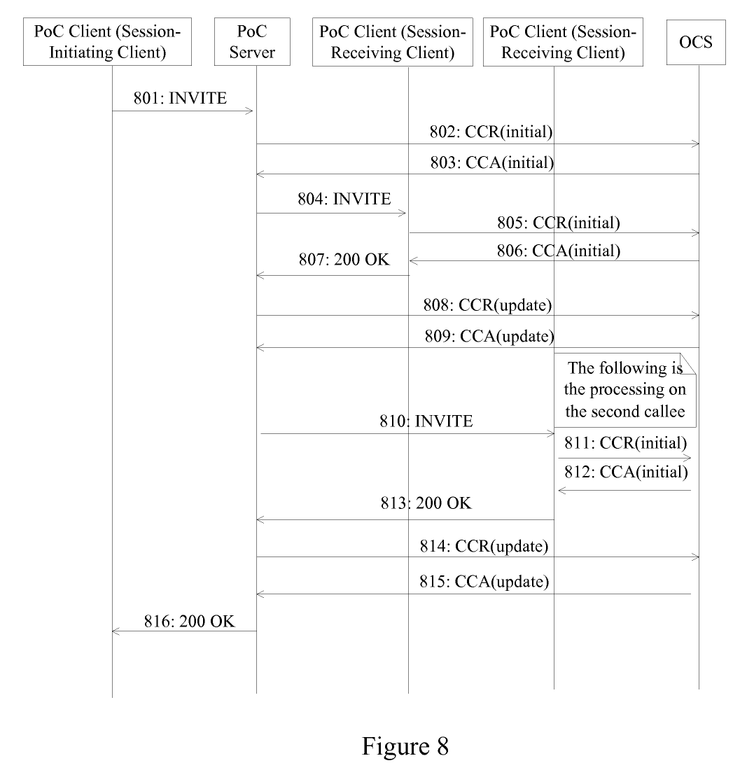

FIG. 8 is a flow chart of online charging when a session-participating client participates in the session according to an embodiment of the invention. Exemplified with two session-participating clients in this embodiment, the process includes:

801) The PoC Client initiates a session request (INVITE);

802) The PoC Server sends a CCR (initial) message to an OCS, where the number of the clients invited to participate in the session is carried in the “Number-Of-Participants” cell of the message;

803) The OCS returns a CCA (initial) to the PoC Server;

804) The PoC Server initiates a session request (INVITE) to the first PoC Client invited to the session;

805) The PoC Client initiates a CCR (initial) to the OCS;

806) The OCS returns a CCA (initial) to the PoC Client;

807) The PoC Client returns a success answer (200 OK) to the PoC Server;

808) The PoC Server sends a CCR (update) message to the OCS, where the updated number of session-participating clients is carried in the “Number-Of-Participants” cell of the message;

809) The OCS returns a CCA (update) to the PoC Server;

810) The PoC Server initiates a session request (INVITE) to the second PoC Client invited to the session;

811) The PoC Client initiates a CCR (initial) to the OCS;

812) The OCS returns a CCA (initial) to the PoC Client;

813) The PoC Client returns a success answer (200 OK) to the PoC Server;

814) The PoC Server sends a CCR (update) message to the OCS, where the updated number of session-participating clients is carried in the “Number-Of-Participants” cell of the message;

815) The OCS returns a CCA (update) to the PoC Server; and

816) The PoC Server returns a success answer (200 OK) to the PoC Client (session-initiating client).

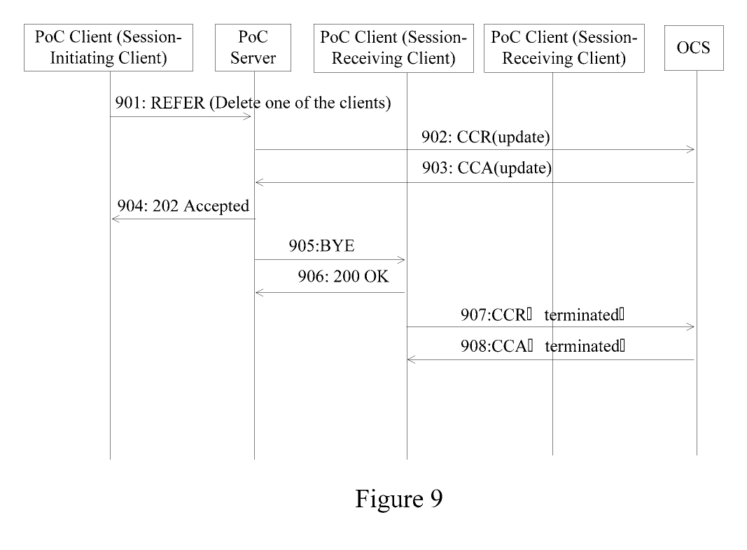

FIG. 9 is a flow of online charging when a session-participating client leaves the session according to an embodiment of the invention. When a client leaves the session, the PoC Server updates the number of session-participating clients by sending a CCR (update) message to an OCS. The process includes:

901) A PoC Client (session-initiating client) sends a deletion request to a PoC Server for deleting one of the session-participating clients;

902) The PoC Server sends a CCR (update) message to the OCS, where the updated number of session-participating clients is carried in the “Number-Of-Participants” cell of the message;

903) The OCS returns a CCA (update) to the PoC Server;

904) The PoC Server returns a deletion-accepted message (202 Accepted) to the PoC Client (session-initiating client);

905) The PoC Server sends a deletion request (BYE) to the PoC Client that leaves the session;

906) The PoC Client that leaves the session returns a deletion success answer (200 OK) to the PoC Server;

907) The PoC Client that leaves the session sends a Credit Control terminating Request, i.e. CCR (terminated) to the OCS; and

908) The OCS returns a Credit Control terminating Answer, i.e. CCA (terminated) to the PoC Client that leaves the session.

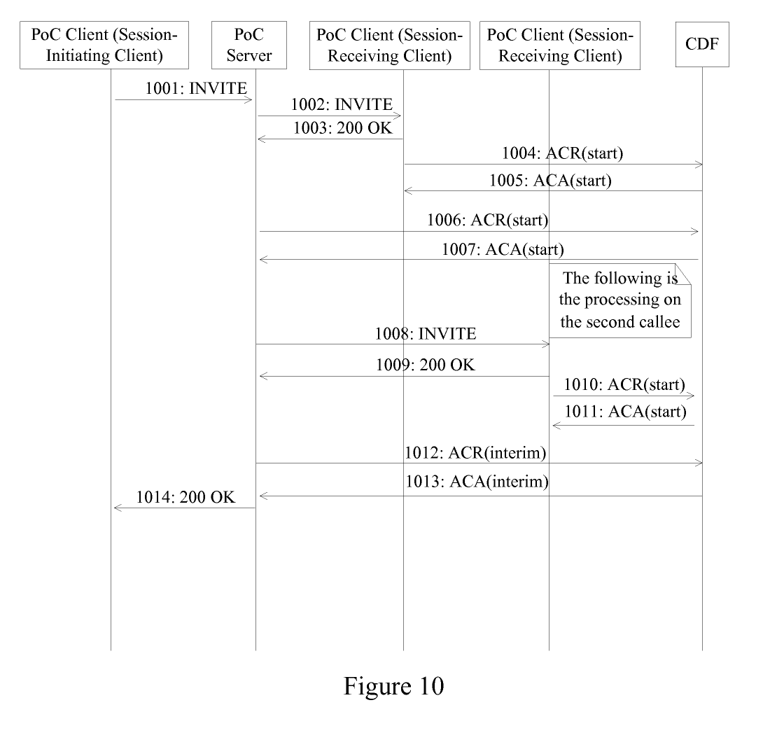

FIG. 10 is a flow chart of offline charging when a session-participating client participates in the session according to an embodiment of the invention. Exemplified with two session-participating clients in this embodiment, the process includes:

1001) A PoC Client (session-initiating client) initiates a session request (INVITE);

1002) A PoC Server initiates a session request (INVITE) to the first PoC Client invited to the session;

1003) The PoC Client returns a success answer (200 OK) to the PoC Server;

1004) The PoC Client initiates an ACR (start) to a CDF;

1005) The CDF returns an ACA (start) to the PoC Client;

1006) The PoC Server sends an ACR (start) message to the CDF, where the number of session-participating clients is carried in the “Number-Of-Participants” cell of the message;

1007) The CDF returns an ACA (start) to the PoC Server;

1008) The PoC Server initiates a session request (INVITE) to the second PoC Client invited to the session;

1009) The PoC Client returns a success answer (200 OK) to the PoC Server;

1010) The PoC Client sends an ACR (start) to the CDF;

1011) The CDF returns an ACA (start) to the PoC Client;

1012) The PoC Server sends an interim accounting request, i.e. ACR (interim) message to the CDF, where the updated number of session-participating clients is carried in the “Number-Of-Participants” cell of the message;

1013) The CDF returns an interim accounting answer, i.e. ACA (interim) to the PoC Server; and

1014) The PoC Server returns a success answer (200 OK) to the PoC Client (session-initiating client).

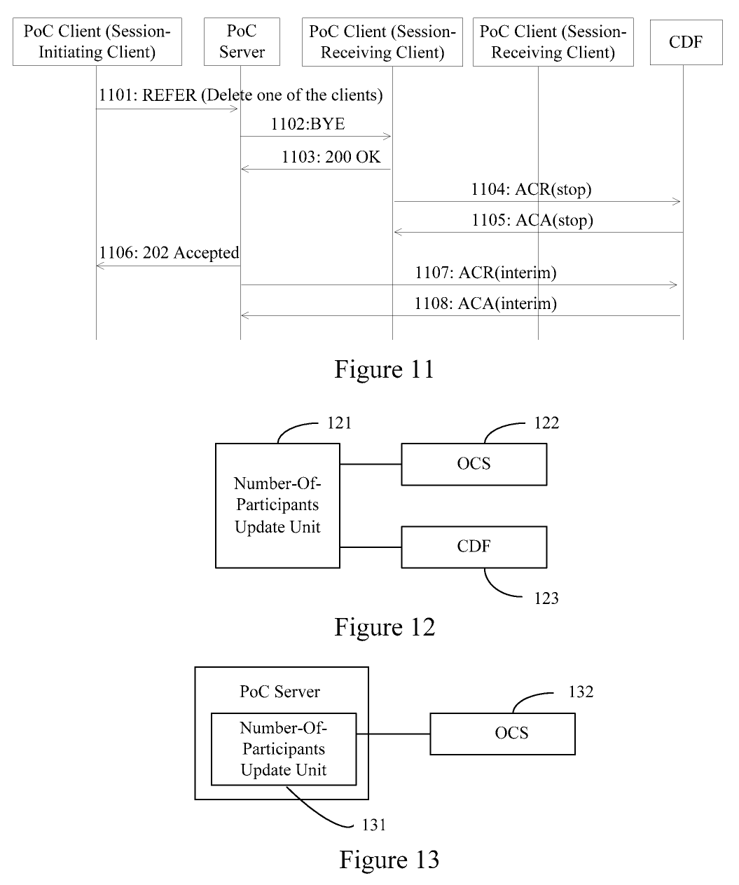

FIG. 11 is a flow chart of offline charging when a session-participating client leaves the session according to an embodiment of the invention. When a client leaves the session, a PoC Server updates the number of the session-participating clients in the message by sending an ACR message to a CDF. The process includes:

1101) A PoC Client (session-initiating client) sends a deletion request to a PoC Server for deleting one of the session-participating clients;

1102) The PoC Server sends a deletion request (BYE) to the PoC Client that leaves the session;

1103) The PoC Client that leaves the session returns a deletion success answer (200 OK) to the PoC Server;

1104) The PoC Client that leaves the session sends an accounting-stop request, i.e. ACR (stop) to the CDF;

1105) The CDF returns an accounting-stop answer, i.e. ACA (stop) to the PoC Client that leaves the session;

1106) The PoC Server returns a deletion-accepted message (202 Accepted) to the PoC Client (session-initiating client);

1107) The PoC Server sends an ACR (interim) message to the CDF, where the updated number of the session-participating clients is carried in the “Number-Of-Participants” cell of the message; and

1108) The CDF returns an ACA (interim) to the PoC Server.

In this embodiment, the structure of the message CCR or ACR that carries the Number-Of-Participants information is described in Table 1 and Table 2, so no further description is provided here.

Additionally, an embodiment of the invention further provides a system for charging a PoC service. The structural diagram of the system is shown in FIG. 12, and the system includes: an OCS 121, a CDF 122 and a Number-Of-Participants update unit 123. Alternatively, the system may include an OCS 121 and a Number-Of-Participants update unit 123; or, the system may include a CDF 122 and a Number-Of-Participants update unit 123. The OCS 121 is adapted to record the charge of a PoC service when the session-participating client is online; and/or the CDF 122 is adapted to record the charge of a PoC service when the session-participating client is offline; and the Number-Of-Participants update unit 123 is connected with OCS 121 or/and CDF 122 respectively, for initiating a CCR (update) to the OCS or initiating an ACR to the CDF, and reporting the number of the session-participating clients, when the number of the session-participating clients changes.

Furthermore, an embodiment of the invention provides a PoC server for online charging, as shown in FIG. 13. The PoC server includes a Number-Of-Participants update unit 131 communicated with an OCS 132. During the online charging of a PoC service, when the number of session-participating clients changes, the Number-Of-Participants update unit 131 sends a CCR (update) message to the OCS 132 and reports the number of the session-participating clients, where the updated number of session-participating clients is carried in the “Number-Of-Participants” cell of the message.

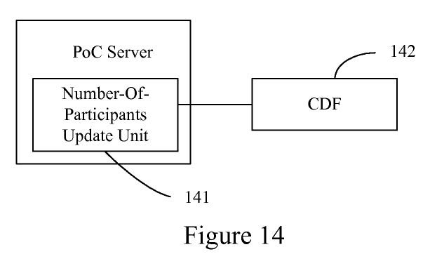

Correspondingly, an embodiment of the invention further provides a PoC server for offline charging, as shown in FIG. 14. The PoC server includes a Number-Of-Participants update unit 141 communicated with a CDF 142. During the offline charging of a PoC service, when the number of session-participating clients changes, the Number-Of-Participants update unit 141 sends an ACR message to the CDF 142 and reports the number of the session-participating clients, where the updated number of the session-participating clients is carried in the “Number-Of-Participants” cell of the message.

The functions and roles of the subsystems or units in the above system or server may refer to the process of the above methods. No further description will be made here.

It can be seen that in the embodiments of the invention, a PoC charging solution based on the number of participants in a PoC session is provided; in other words, in the embodiments of the invention, an online and offline charging mode when the number of participants changes is provided. In particular, during the online charging of a PoC session, the number of clients written in the CCR message is the number of clients invited to participate in the session by the session-initiating client. If the number of participants changes (increases or decreases), the Number-Of-Participants information is re-written and updated via a CCR message; and the re-written Number-Of-Participants is the actual number of the session-participating clients at present. Similarly, during the offline charging of a PoC session, if the number of the session-participating clients changes (increases or decreases), the Number-Of-Participants information is re-written and updated via an ACR message; and the re-written Number-Of-Participants is the actual number of the session-participating clients at present. Therefore, in the technical solutions according to the embodiments of the invention, a charging mode based on the number of session-participating clients may be provided to the user. This charging mode is simple and flexible, and it can meet the demands of the carrier on diversified charging, thus the user satisfaction level may be improved.

The description above is only for the exemplary embodiments, and not used to limit the scope of the invention. Accordingly, various modifications, equivalent substitutions and improvements made without departing from the spirit or scope of the invention shall be covered within the scope of the invention defined by the appended claims and their equivalents.

1. A method for online charging a Push-to-Talk over Cellular, PoC, service, comprising:
initiating, by a PoC server, a Credit Control update Request, CCR (update), to an Online Charging System, OCS, and reporting the number of the session-participating clients through the CCR (update), when the number of session-participating clients changes.

2. The method according to claim 1, wherein, when an invited client participates in the session, the initiating the CCR (update) to the OCS and reporting the number of the session-participating clients through the CCR (update) comprises:
initiating, by the PoC server, a session request to the client invited to participate in the session, and receiving a success answer sent by the client invited to participate in the session;
sending, by the PoC server, a CCR (update) to the OCS and reporting the number of the session-participating clients through the CCR (update), and receiving a Credit Control update Answer, CCA (update), sent by the OCS.

3. The method according to claim 2, further comprising:
initiating, by the client invited to participate in the session, a Credit Control Request, CCR, to the OCS, and
returning, by the OCS, a Credit Control Answer, CCA, to the client invited to participate in the session.

4. The method according to claim 1, wherein, when a session-participating client leaves the session, the initiating the CCR (update) to the OCS and reporting the number of the session-participating clients through the CCR (update) comprises:
initiating, by the PoC server, a CCR (update) to the OCS, reporting the number of the session-participating clients CCR (update), and receiving a CCA (update) sent by the OCS; and
initiating, by the PoC server, a deletion request to the client that leaves the session, and receiving a deletion success answer sent by the client that leaves the session.

5. The method according to claim 4, wherein, further comprising:
initiating, by the client that leaves the session, a Credit Control terminating Request, CCR (terminated), to the OCS, and
returning, by the OCS, a Credit Control terminating Answer, CCA (terminated), to the client that leaves the session.

6. The method according to claim 1, wherein, the number of the session-participating clients is carried in a “Number-Of-Participants” cell of the CCR (update).

7. A method for offline charging a PoC service, comprising:
initiating, by a PoC server, an Accounting Request (ACR) to a Charging Data Function, CDF, entity and reporting the number of the session-participating clients through the ACR, when the number of session-participating clients changes.

8. The method according to claim 7, wherein, when an invited client participates in the session, the initiating the ACR to the CDF and reporting the number of the session-participating clients through the ACR comprises:
initiating, by the PoC server, a session request to the client invited to participate in the session, and receiving a success answer sent by the client invited to participate in the session; and
initiating, by the PoC server, the ACR to the CDF, reporting the number of the session-participating clients through the ACR, and receiving an Accounting Answer, ACA, sent by the CDF.

9. The method according to claim 8, wherein, further comprising:
sending, by the client invited to participate in the session, the ACR to the CDF, and
returning, by the CDF, the ACA to the client invited to participate in the session.

10. The method according to claim 7, wherein, when a session-participating client leaves the session, the initiating the ACR to the CDF and reporting the number of the session-participating clients through the ACR comprises:
initiating, by the PoC server, a deletion request to the client that leaves the session, and receiving a deletion success answer sent by the client that leaves the session; and
initiating, by the PoC server, the ACR to the OCS, reporting the number of the session-participating clients through the ACR, and receiving an ACA sent by the OCS.

11. The method according to claim 10, further comprising:
sending, by the client that leaves the session, an Accounting-stop Request, ACR (stop), to the CDF, and
returning, by the CDF, an Accounting-stop Answer, ACA (stop), to the client that leaves the session.

12. The method according to claim 7, wherein, the number of the session-participating clients is carried in a “Number-Of-Participants” cell of the ACR.

13. A PoC server for online charging, configured to communicate with an OCS and online charge a PoC service, wherein, the PoC server comprises:
a Number-Of-Participants update unit, adapted to initiate a CCR (update) to the OCS and report the number of session-participating clients through the CCR (update) when the number of the session-participating clients changes.

14. The PoC server according to claim 13, wherein, the number of the session-participating clients is carried in a “Number-Of-Participants” cell of the CCR (update).

15. A PoC server for offline charging, configured to communicate with a CDF and offline charge a PoC service, wherein, the PoC server comprises:
a Number-Of-Participants update unit, adapted to initiate an ACR to the CDF and report the number of session-participating clients through the ACR when the number of the session-participating clients changes.

16. The PoC server according to claim 15, wherein, the number of the session-participating clients is carried in a “Number-Of-Participants” cell of the ACR.

17. A system for charging a PoC service, comprising:
an OCS, adapted to charge the PoC service when the session-participating client(s) is online; and/or
a CDF, adapted to charge the PoC service when the session-participating client(s) is offline; and
a Number-Of-Participants update unit connected with the OCS and/or the CDF respectively, adapted to initiate a CCR (update) to the OCS, and report the number of the session-participating clients through the CCR (update), and/or initiate an ACR to the CDF, and report the number of the session-participating clients through the ACR, when the number of the session-participating clients changes.
